(19) United States
(12) Patent Application Publication
(10) Pub. No.: US 2010/0220008 A1
(43) Pub. Date: Sep. 2, 2010

(54) SYSTEM AND METHOD FOR OPTIMAL TIME, POSITION AND HEADING SOLUTION THROUGH THE INTEGRATION OF INDEPENDENT POSITIONING SYSTEMS

(75) Inventors: Zachariah Conover, Standish, ME (US); Michael R. Leathem, Brownfield, ME (US); David Rubenstein, Falmouth, ME (US)

Correspondence Address: CHRIS A. CASEIRO, VERRILL DANA, LLP, ONE PORTLAND SQUARE, PORTLAND, ME, 04112-0586, US

(73) Assignee: CROSSRATE TECHNOLOGY LLC, Windham, ME (US)

(21) Appl. No.: 12/703,268

(22) Filed: Feb. 10, 2010

Related U.S. Application Data
(63) Continuation-in-part of application No. PCT/US07/23561, filed on Nov. 8, 2007.
(60) Provisional application No. 60/955,086, filed on Aug. 10, 2007.

(51) Int. Cl. G01S 19/46

(52) U.S. Cl. 342/357.29

(57) ABSTRACT

A system for, and method of, blending (or integrating) pseudo-range or position measurements and bearing-to-transmitter measurements from an eLORAN or LORAN-C receiver and position (alternatively, pseudo ranges) and velocity (alternatively pseudo-range rate) measurements from a GPS receiver. The described system can also be integrated with additional external positioning systems. In the context of an inertial navigation system (INS) application, this combined GPS/LORAN signal can be employed to provide external positioning solutions, potentially integrated with measurements from devises such as accelerometers, gyroscopes, altimeters, etc. The system includes a GPS signal input, a LORAN signal input, preprocessors for each, and an integrator to combine the two preprocessed signals to estimate errors in the full trajectory variables.

### CROSS REFERENCE TO RELATED APPLICATION

The present application is a continuation-in-part, and claims the priority benefit, of PCT application serial number PCT/US2007/023561 filed Nov. 8, 2007, entitled “SYSTEM AND METHOD FOR OPTIMAL TIME AND POSITION SOLUTION THROUGH THE INTEGRATION OF INDEPENDENT POSITIONING SYSTEMS”, which claims the priority benefit of U.S. provisional patent application Ser. No. 60/955,086, filed Aug. 10, 2007, entitled “SYSTEM AND METHOD FOR OPTIMAL TIME AND POSITION SOLUTION THROUGH THE INTEGRATION OF INDEPENDENT POSITIONING SYSTEMS” of the same named inventors. The entire content of the prior applications is incorporated herein by reference.

### BACKGROUND OF THE INVENTION

1. Field of the Invention

The present invention relates to a system for, and method of, blending (or integrating) pseudo-range measurements and bearing-to-transmitter (“bearing”) measurements from an eLORAN or LORAN-C receiver and position (alternatively, pseudo ranges) and velocity measurements from a GPS receiver. The described system can also be integrated with additional external positioning systems including but not limited to DGPS, WAAS enabled GPS, GNSS, GLONASS, Chayka, TACAN, VOR, Compas Omega, signals of opportunity systems, Galileo and Eurofix. In the context of an inertial navigation system (INS) application, this combined GPS/LORAN signal can be employed to provide external positioning solutions, potentially integrated with measurements from devises such as accelerometers, gyroscopes, altimeters, etc.

2. Description of the Prior Art

LORAN (Long Range Navigation) is a terrestrial navigation system composed of chains of low frequency radio transmitters that are used to determine position of receivers. Presently, the U.S. Coast Guard is developing the LDC, also referred to as eLORAN, or enhanced LORAN. The purpose of eLORAN is to supplement the current LORAN-C (version C) system with a differential capability that will provide information such as, absolute time, Differential LORAN corrections, anomalous propagation (early skywave) warnings, and LDC system information for high-integrity applications. The addition of these capabilities will greatly increase the accuracy and utility of the Loran system. This differential capability is implemented and transmitted using 32-state Pulse Position Modulation technique on an additional Loran pulse (ninth pulse) added in every Group Repetition Interval (GRI.) By utilizing these capabilities at a receiver, it becomes practical to integrate this higher accuracy Loran with additional positioning sensors. What is needed is a method and related system to blend or integrate pseudo-range or position measurements as well as bearing measurements from an eLORAN or LORAN-C receiver and position or pseudo ranges and velocity measurements from an external positioning system such as, for example, a Global Positioning System (GPS) receiver.

### SUMMARY OF THE INVENTION

The present invention is a LORAN/GPS (LG) integrator implemented as a discrete-time, linear Kalman Filter in computer program-based algorithms to compute optimal measurement updates when observations are available as well as for propagation steps between observations. The algorithm can accommodate various measurement scenario permutations involving the presence or absence of GPS and/or LORAN observations at different times. The output of this program is the optimal trajectory estimates of position, velocity and true heading-from-north (“heading”) as well as corrective factors to mitigate portions of the measurement errors from various sources.

This and other advantages of the present invention will be noted upon review of the following detailed description, the accompanying drawings and the appended claims.

### BRIEF DESCRIPTION OF THE DRAWINGS

FIG. 1 shows a block diagram describing the high-level flow of data and processing of the LG Integrator and its immediate environment.

FIG. 2 shows a block diagram describing the basic hierarchy of heading sub-modes associated with fully integrated navigation solution and interactive bearing measurement calibration.

FIG. 3 shows a processing block diagram for the GPS measurement update step for one embodiment which includes GPS position and velocity data as measurements.

FIG. 4 shows a processing block diagram for an eLORAN measurement update step.

### DETAILED DESCRIPTION OF THE PREFERRED EMBODIMENT

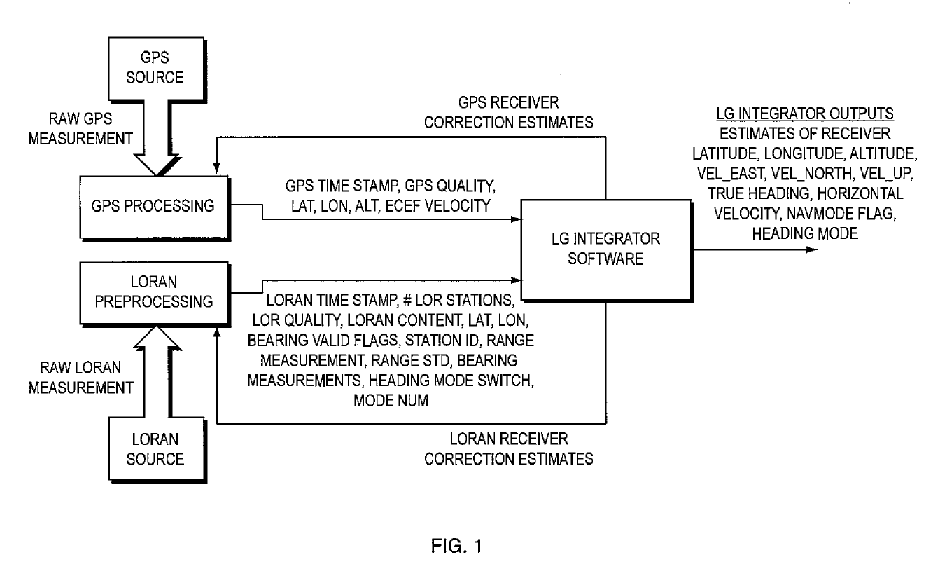

A LG integrator of the present invention is shown in simplified block form in FIG. 1, which provides a high-level representation of the flow of data and processing of the LG Integrator and its immediate environment. The block with horizontal lines represents actual LG Integrator functionality, which may be embodied in hardware, software, or a combination of the two, the blocks with slanted lines represent external functions, which also may be embodied in hardware, software or a combination of the two, and the blocks with vertical lines represent receivers or signal sources.

A raw LORAN signal (Time-of-Arrivals, etc.) is preprocessed to produce the required input string for the integrator. This includes the following items depicted in FIG. 1:
1. LORAN clock generated time-stamps (one for each measured pseudo range).
2. Number of valid transmitter stations (for which a pseudo-range is to be provided).
3. LORAN quality indicator.
   a. “Mode 1”=Standard LORAN-C.
   b. “Mode 2”=Enhanced eLORAN.
   c. “Mode 3”=LORAN-C.
4. LORAN content indicator.
   a. “Mode 3”=LORAN-C Time-difference (TD) mode.
   b. “Mode 2”=Full LORAN mode, pseudo-ranges and position fix.
   c. “Mode 1”=Partial LORAN mode, pseudo-ranges only.
   d. “Mode 0”═No valid LORAN information.
5. LORAN latitude fix (if available).
6. LORAN longitude fix (if available).
7. Pseudo-range data sets.
   a. Index (identifier) of specific (i^{th}) LORAN transmitter.
   b. LORAN (i^{th}) pseudo-range measurement.
8. LORAN (i^{th}) pseudo-range Signal-to-Noise Ratio (SNR).
9. LORAN bearing measurements (1->NumBearings, maximum of 10).
10. LORAN bearing measurement availability flags (indicates whether bearing measurement is available for each range-producing station).
11. Heading automatic-mode switch (defines whether heading mode selection is autonomous or manual).
12. Heading mode indicator (defines heading sub-mode if in manual selection mode).

Similarly, the GPS source signal is also preprocessed to produce the required input string for the integrator. This includes the following items also depicted in FIG. 1:
1. GPS clock generated time-stamp.
2. GPS quality indicator.
   a. “Mode 2”=Differential GPS/WAAS.
   b. “Mode 1”=Standard GPS.
   c. “Mode 0”=No valid GPS information.
3. GPS latitude fix.
4. GPS longitude fix.
5. GPS altitude fix.
6. GPS velocity east.
7. GPS velocity north.
8. GPS velocity up.
9. Optionally GPS pseudo-range and pseudo-range-rate data sets.
   a. GPS (i^{th}) pseudo-range measurement.
   b. GPS (i^{th}) pseudo-range-rate measurement.
   c. GPS (i^{th}) satellite ephemeris set.
10. GPS Position Error Data.

The LG Integrator is designed to process a variety of different heading sub-modes. These sub-modes may be entered via user selection (Manual Heading Mode) or autonomous selection (Automatic Heading Mode) by the software. Table 1 summarizes the various Heading sub-modes.

TABLE 1
Heading Sub-modes for LG Integrator

| Heading | Sub-mode | |
|---|---|---|
| Mode # | Name | Description |
| 1 | BAV_NoCal | Integrating velocity information with |
| | | bearing for heading estimates. No previous |
| | | bearing calibration data available. |
| 2 | BO_NoCal | Heading estimation based on bearing |
| | | measurements alone. No previous bearing |
| | | calibration data available. |
| 3 | BAV_PostCal | Integrating velocity information with |
| | | bearing for heading estimates. Parameters |
| | | for bearing measurement error |
| | | compensation are available from a previous |
| | | calibration process. |
| 4 | BO_PostCal | Heading estimation based on bearing |
| | | measurements alone. Parameters for bearing |
| | | measurement error compensation are |
| | | available from a previous calibration |
| | | process. |
| 5 | PosVel | Position and velocity estimates only, to |
| | | provide a converged initialization for the |
| | | calibration modes. |
| 6 | BAV_Cal | Bearing measurement calibration mode, |
| | | with velocity and bearing both correlated to |
| | | heading estimates. |
| 7 | BO_Cal | Bearing measurement calibration mode, |
| | | with bearing measurements only correlated |
| | | to heading estimates. |

The primary considerations driving the existence of the various heading modes are: 1) to provide the capability for a full integrated navigation solution while correlating velocity and heading states or so as to avoid this correlation, depending on specific situations and user preferences; and 2) to allow for an interactive bearing measurement calibration procedure and the implementation of the resulting correction factors. To accommodate item #1 above, the two state-space formulations (discussed in the algorithm formulation section below) BO (BearingOnly) and BAV (BearingAndVelocity) have been developed. The BO sub-modes are designed to allow only LORAN bearing measurements, and those states tied to the bearing measurement, to influence the heading estimates. These state-spaces do not accommodate any correlation between velocity and heading. This is the preferred formulation when the velocity direction is not substantially aligned with the forward axis of the platform.

The BAV sub-modes are designed to provide full coupling between system velocity and heading. In this case, all velocity state information as well as velocity measurements and bearing measurements are correlated to the heading estimation. This is the preferred formulation for situations where the velocity direction is sufficiently aligned with the forward axis of the platform. Additionally regarding Table 1, the BAV and BO formulations are applied to various situations including that associated with bearing measurement calibration (“_Cal”), post calibration, when the resulting correction factors are available for implementation (“_PostCal”) and no calibration (“_NoCal”) when no previous calibration has been done or is desired.

The “PosVel” mode is intended as a means of calibration initialization. This filter allows for an efficient and expedient convergence on a position and velocity solution which can than enable a stable initial state for the calibration process. This eliminates the requirement for the calibration filter to simultaneously provide position and velocity estimates, potentially from a poor initial guess, while executing the calibration estimation.

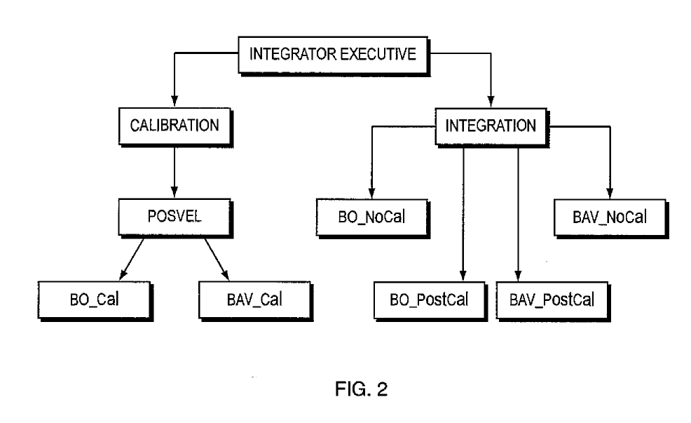

The basic hierarchy of the heading sub-modes is shown in FIG. 2. The calibration-only sub-modes are shown in boxes with vertical lines. The sub-modes associated with nominal integration, either without calibration, or post calibration, are shown with horizontal lines. The nominal integration processing (non-calibration) can operate in BAV_NoCal, BO_NoCal, BAV_PostCal or BO_PostCal submodes. The calibration processing can operate in either BAV_Cal or BO_Cal submodes, with the PosVel sub-mode available to support initialization.

The LG Integrator is also designed to accommodate a number of input measurement content permutations within the processing of any heading submode. Each of these permutations results in the setting of a different Navigation Mode (“NavMode”) within the LG Integrator. The accommodated permutations and their corresponding NavMode are shown below, in Table 2.

TABLE 2
Navigation Modes of Operation for LG Integrator

| Navigation Mode | | |
|---|---|---|
| (NavMode) | GPS Message Type | LORAN Message Type |
| LOR_ALL_GPS | Differential or Standard | Full (Mode 2) |
| | (Mode 2 or 1) | |
| LOR_RNG_GPS | Differential or Standard | Partial (Mode 1) |
| | (Mode 2 or 1) | |
| GPS | Differential or Standard | Failure (Mode 0) |
| | (Mode 2 or 1) | |
| LOR_TD | Failure (Mode 0) | TD (Mode 3) |
| LOR_POS | Failure (Mode 0) | Full (Mode 2) |
| LOR_RNG | Failure (Mode 0) | Partial (Mode 1) |
| NONE | Failure (Mode 0) | Failure (Mode 0) |

The LG Integrator processing flow is specific to the Navigation Mode setting and attempts to utilize any available information to improve the positioning solution. The processing of partial measurements is, effectively, a subset of the processing required for the full measurement input sets. Descriptions of the processing of full LORAN and full GPS measurements are shown in the “Measurement Processing” subsections below.

With reference to FIG. 1, the primary outputs of the LG Integrator are as follows:
1. Receiver latitude solution.
2. Receiver longitude solution.
3. Receiver altitude solution.
4. Receiver east velocity solution.
5. Receiver north velocity solution.
6. Receiver up velocity solution.
7. LORAN correction term solutions.
   a. LORAN receiver clock bias correction,
   b. LORAN (i^{th}) individual range corrections.
8. Receiver heading solution.
9. Receiver horizontal velocity solution.
10. Initialization phase complete indication.
11. Navigation mode indicator.
12. Heading mode indicator.
13. Integrator information providing insight into accuracy of solution (Optionally including latitude/longitude/altitude error states, latitude/longitude/altitude covariance states or combinations thereof.)

The LG integrator utilizes a Kalman Filter approach to optimally combine the GPS and LORAN information. Filters that resolve the indicated sub-modes of the LG Integrator are structured as error-state filters meaning errors in trajectory variables are estimated rather than the trajectory variables themselves. This approach, common in many navigation implementations, is compatible with the linear dynamics requirement of the filter.

As alluded to above and in regard to Table 1, the LG Integrator accommodates seven heading sub-modes. There is a corresponding state-space for each of these as discussed below.

BearingAndVelocity with no Calibration (BAV_NoCal Mode)—state-space to provide for the correlation between velocity and heading, with no bearing calibration information available,

\hat{x}_{BAV}_{_{—}}_{NoCal}=[δ_{φ}δ_{λ}δₕδ_{V}_{_{H}}δ_{V}_{_{U}}δ_{ψ}δ_{B}_{_{L}}δ_{A}_{₀}] (1)

In equation (1), the first three terms represent the errors in the estimates of receiver latitude, longitude and altitude. The next three terms represent the errors in the estimates of receiver horizontal and vertical velocity and heading. The seventh term is a bias correction estimate for the LORAN range measurements. In the preliminary version, this term accounts for the LORAN receiver clock bias as well as ASP compensation uncertainty, primarily for the case of a static receiver location. The final term in the BAV_NoCal filter state-space is a bias error state to provide a simplified on-line, single-term bearing error correction. Although this is not designed to replace a full calibration procedure, it will accommodate users who, for whatever reason, are not interested in executing the full calibration function. Instead, this parameter will allow for automatic linear-term correction, computed and implemented entirely by the software.

BearingOnly with no Calibration (BO_NoCal Mode)—state-space which precludes the correlation between velocity and heading, with no bearing calibration information available.)

\hat{x}_{BO}_{_{—}}_{NoCal}=[δ_{φ}δ_{λ}δₕδ_{V}_{_{E}}δ_{V}_{_{N}}δ_{V}_{_{U}}δ_{ψ}δ_{B}_{_{L}}] (2)

In equation (2), the first three terms represent the errors in the estimates of receiver latitude, longitude and altitude. The next four terms represent the errors in the estimates of receiver east, north and vertical velocity and heading. The eighth term is a bias correction estimate for the LORAN range measurements. In the preliminary version, this term accounts for the LORAN receiver clock bias as well as ASF compensation uncertainty, primarily for the case of a static receiver location. Since estimation of the single-term bearing measurement error correction requires that the velocity information is correlated with the heading state, the parameter cannot be independently computed in this formulation.

BearingAndVelocity Post Calibration (BAV_PostCal Mode)—state-space to provide for the correlation between velocity and heading, with bearing calibration information available from a previous calibration procedure.

\hat{x}_{BAV}_{_{—}}_{PostCal}=[δ_{φ}δ_{λ}δₕδ_{V}_{_{H}}δ_{V}_{_{U}}δ_{ψ}δ_{B}_{_{L}}] (3)

In this filter, the previously computed and stored bearing corrections are used to compensate the measurements. There are no additional correction parameters included in the estimator state-space. The state-space shown in equation (3) is identical to that shown in equation (1) with the exception of the single correction parameter which is not needed here since the entire error model is available to the integrator.

BearingOnly Post Calibration (BO_PostCal)—state-space which precludes the correlation between velocity and heading, with bearing calibration information available from a previous calibration procedure. This is identical to the state-space shown in equation (2). Here the bearing error model parameters from the previous calibration are available to the integrator for compensating the bearing measurements.

\hat{x}_{BO}_{_{—}}_{PostVel}=[δ_{φ}δ_{λ}δₕδ_{V}_{_{E}}δ_{V}_{_{N}}δ_{V}_{_{U}}δ_{ψ}δ_{B}_{_{L}}] (4)

PositionAndVelocity (PosVel)—state-space to be utilized for pre-calibration mode, in order to acquire improved position and velocity states to initialize the calibration filter. No heading states are included and bearing measurements are ignored.

\hat{x}_{PosVel}=[δ_{φ}δ_{λ}δₕδ_{V}_{_{E}}δ_{V}_{_{N}}δ_{V}_{_{U}}δ_{B}_{_{L}}] (5)

BearingAndVelocity for Calibration (BAV_Cal Mode)—state-space for full bearing measurement calibration where velocity is completely or sufficiently in the direction of forward (heading). The calibration process will require specific maneuvers including forward velocity for some duration to estimate the bias term (A) and a rotation sequence to capture the heading dependent coefficients (B-E).

\hat{x}_{BAV}_{_{—}}_{Cal}=[δ_{φ}δ_{λ}δₕδ_{V}_{_{H}}δ_{V}_{_{U}}δ_{ψ}δ_{B}_{_{L}}δ_{A}_{₀}δ_{B}_{₀}δ_{C}_{₀}δ_{D}_{₀}δ_{E}_{₀}] (6)

In equation (6), as with the previous BAV filters, the first three elements are the latitude, longitude and altitude, and the next three are the horizontal and vertical velocity and heading. The single-term range bias state is next followed by the five bearing measurement error model parameters, A-E.

BearingOnlyMode for Calibration (BO_Cal Mode)

\hat{x}_{BO}_{_{—}}_{Cal}=[δ_{φ}δ_{λ}δₕδ_{V}_{_{E}}δ_{V}_{_{N}}δ_{V}_{_{U}}δ_{ψ}δ_{B}_{_{L}}δ_{A}_{₀}δ_{B}_{₀}δ_{C}_{₀}δ_{D}_{₀}δ_{E}_{₀}] (7)

The BO_Cal mode is the state-space for full bearing measurement calibration where velocity is insufficient or otherwise undesired for purposes of the calibration process. The calibration sequence will require specific maneuvers including forward velocity for a TBD duration to establish the bias term (A) and a rotation sequence to capture the heading dependent coefficients (B->E).

The LG Integrator may be modified so as to estimate corrections of specific, individual LORAN range/path errors by providing a filter than can “learn” of or gain insight into these errors while GPS is present. Then, in the absence of GPS, the individual LORAN ranges can be compensated with these corrections allowing primarily for improved LORAN-only navigation. In order to accomplish this, certain state variables may be added to the state-spaces described above to accommodate the individual ASF (or range) correction terms, for each active LORAN transmitter.

The LORAN path conductivity error states may be summarized as the sum of the temporal errors plus the spatial errors:

δ_{ASF}(i)=δ_{T}(i)+δ_{S}(i) (i=→Nₜᵣₐₙₛₘᵢₜₜₑᵣₛ) (8a)

so

\dot{δ}_{ASF}(i)=\dot{δ}_{T}(i)+\dot{δ}_{S}(i) (8b)

where the index “i” represents the i^{th} Loran transmitter.

Temporal Term Compensation

The temporal component (δ_{T}) is composed of short-term and long-term parts. The short-term parts are composed of “path-dependent” elements and “local” elements:

δ_{T}(i)=δ_{long}(i)+δₛₕₒᵣₜ(i)=δ_{long}(i)+(δₚₐₜₕ(i)+δ_{local}(i)) (9a)

therefore

\dot{δ}_{T}(i)=\dot{δ}_{long}(i)+[\dot{δ}ₚₐₜₕ(i)+\dot{δ}_{local}(i)] (9b)

The long-term element in equation (9b) can be modeled as a constant bias plus process noise:

\dot{δ}_{long}(i)=w_{long}

w_{long}(i)=wₗₙ+F(Δt_{GPS})

In equation (10), the process noise is described as a function of elapsed time since GPS outage plus a nominal noise term. In this way, the quality of the model will diminish with time away from GPS. When GPS is present, the noise will be small, with a nominal noise term only. It is also possible that the long-term temporal effect can be assimilated into the overall range/clock bias described in the nominal state spaces. This is the case for the short-term, local element which will have roughly the identical effect on all transmitter measurements. This error term can be assimilated into the LORAN clock bias state.

The short-term temporal component from transmission path effects (δₚₐₜₕ) will vary according to weather and other conditions along the path from transmitter to receiver. This can be modeled as a Gauss-Markov process:

$${\dot{δ}}_{path} = - \frac{{δ}_{path} ( i )}{{τ}_{path} ( i )} + {w}_{path} ( i ) \\ {w}_{path} ( i ) = F ( Δ {t}_{GPS} ) + {w}_{sn} \qquad ( 11 )$$

In equation (11), τ is the correlation time constant for this process and wₛₙ is another nominal process noise value. Again, this formulation will allow the model uncertainty to grow with elapsed time since GPS presence, beyond the uncertainty which the internal covariances will exhibit.

Spatial Term Compensation

The effect of spatial variations on the \dot{δ}_{ASF} in equation (8b) is given by the \dot{δ}_{S} term. The spatial changes of the ASP are similar to the path dependent temporal component in that, for a static receiver or very slowly moving receiver, the phenomena may be modeled with a Gauss-Markov process such as given by the following difference equation:

δ(k+1)=e^{-βΔd}δₛ(k)+wₛ(k) (12)

In equation (12), Δd is the distance traversed between filter updates and β=1/τ, the correlation time constant. The wₛ term is the process noise for the spatial error component. Equation (12) can be linearized and utilized in the integrator to model the spatial variations of the ASF over the Δt associated with consecutive estimator time-steps.

In equation (12), it should be noted that the exponent term in distance can be related to the estimation time-step by estimated velocity (V):

Δd=∥V∥Δt (13)

Thus the continuous-time version of equation (12) is:

$${\dot{δ}}_{s} ( i ) = - ( \frac{1}{{τ}_{s}} ‖ V ‖ ) {δ}_{s} ( i ) + {w}_{s} ( i ) \\ {w}_{s} ( i ) = F ( Δ {t}_{GPS} ) + {w}_{sn} \qquad ( 14 )$$

This model can be implemented in the LG Integrator in a manner similar to the LORAN clock bias model. It would remain to determine the effective correlation constant τₛ through analysis, etc. τ may be “highly terrain dependent” and should be “adaptable to terrain variations”. That is, for flat, benign terrain which would produce a lower rate-of-change of the spatial ASF, this time-constant would be a large value. For a changeable terrain, such as a mountain range, the time-constant should be smaller.

State-Space Augmentation for Individual Path Corrections

The state-spaces discussed above can be augmented to include the components needed for the estimation of the individual LORAN path corrections. For example, in the BAV_NoCal Mode, the state space would be:

$${{X}^{̑}}_{BAV \_ NoCal} = [ \begin{matrix}{δ}_{φ} {δ}_{λ} {δ}_{h} & {δ}_{{V}_{H}} {δ}_{{V}_{U}} {δ}_{ψ} & {δ}_{{B}_{L}} {δ}_{{A}_{0} } … \\ {δ}_{long} ( i -> {N}_{T )} & {δ}_{path} ( i -> {N}_{T} ) & {δ}_{S} ( i -> {N}_{T} )\end{matrix} ] \qquad ( 15 )$$

where the added terms in the second row of the state vector represent the corrections to all the individual (i^{th}) LORAN range measurements to accommodate path conductivity model errors. Since the resulting state-space may be large, with additional parameters for each transmitter, and dynamic as the number and location of the transmitters change, special accommodations may need to be made in the associated algorithms and computer code.

The receiver provides the LG Integrator with the specified inputs from both GPS and LORAN data streams, shown in the listings above and depicted in FIG. 1. These measurements are processed in the filter individually (in series), the observation with the earlier time-stamp being processed first. Optionally, they may be processed in parallel, formulated as a single measurement update. The associated measurement updates are incorporated into the state and the covariances in the same sequence, corresponding to the time-stamp of the specific observable signal.

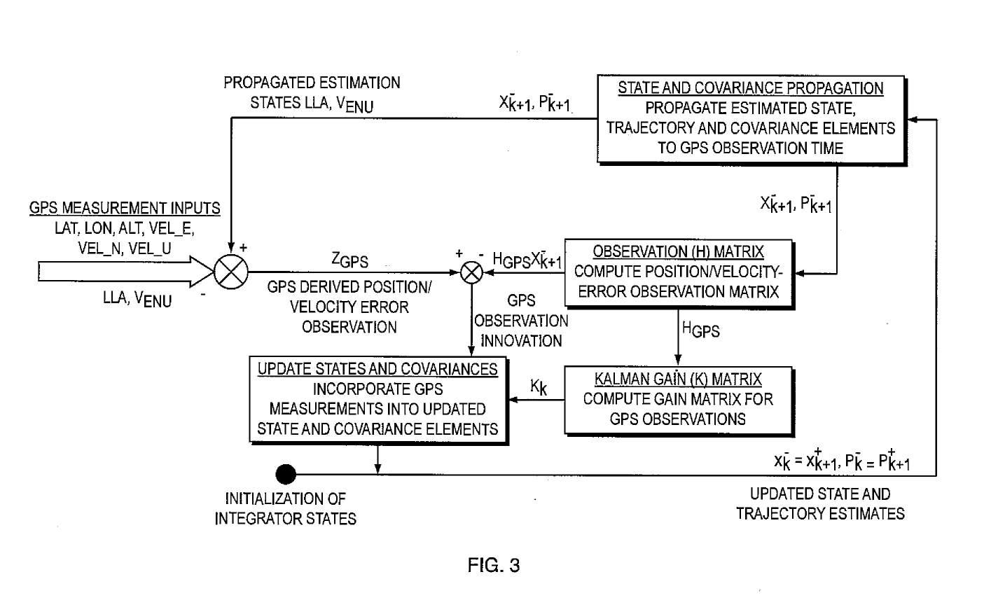

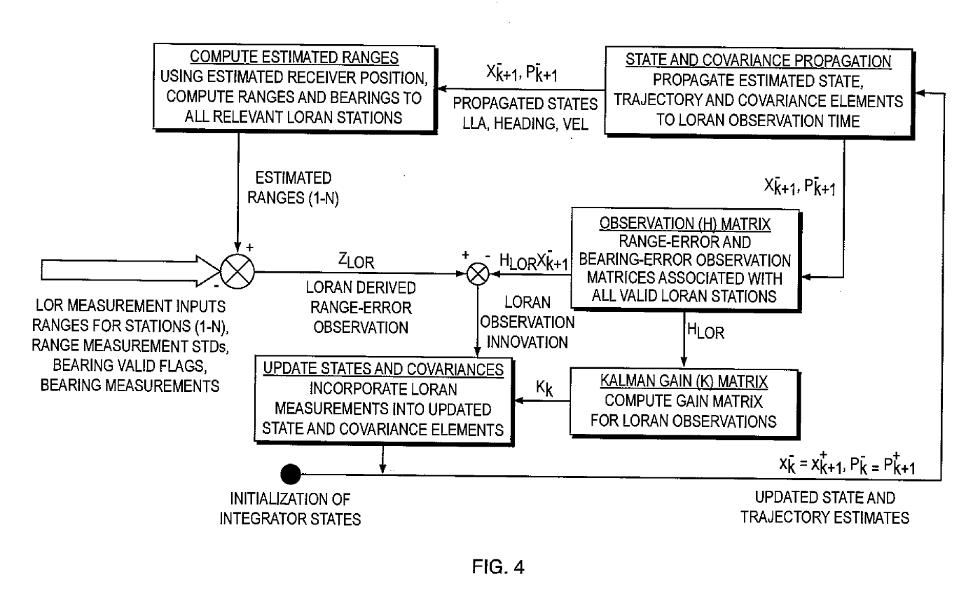

In FIGS. 3 and 4, the subscript “k” alludes to the k^{th} time step where as the ensuing step is written as “k+1”. Also, the superscript “+” indicates that the state represented is after incorporation of the specific measurement while “−” indicates that this is the state just prior to the incorporation of the measurement. The processing of the two measurement types are depicted individually, for clarity, as shown in FIGS. 3 and 4.

As represented in FIG. 3, the processing block diagram for the GPS measurement update step is shown (this is specific to the design option which does not include the GPS pseudo-ranges as measurements). Inputs (the position and velocity measurements identified herein) are differenced with the filter's current estimate of the corresponding states. This produces position and velocity (and optionally heading) error signals, the true observations for the LG Integrator filter. The states and covariances are then updated according to these observations together with the corresponding Kalman Gain Matrix (K) and the GPS Observation Matrix (H_{GPS}), using the standard Kalman Filter formulations known to those of ordinary skill in the art. These updated states and covariances are then propagated to the time of the next observation—in this implied “sample” sequence the eLORAN measurements.

As represented in FIG. 4, the processing block diagram for an eLORAN measurement update step is shown. In this embodiment of the LG integrator, the ranges to all utilized eLORAN transmitter stations are input and differenced with the estimator's version of these ranges, computed using the estimated receiver position and the known station locations. The estimated range is the distance, which may be determined by the Vincenty Method described in Direct and Inverse Solutions of Geodesics on the Ellipsoid with Application of Nested Equations, Survey Review, DMAAC Geodesic Survey Squadron, Warren AFB, Wyoming, April 1975, incorporated herein by reference, between current estimated receiver latitude/longitude and the specific transmitter latitude/longitude. The receiver position has previously been propagated to the time of the LORAN observation using a first-order propagation method. This difference produces the LORAN observable, the range error signal, for each active transmitter. This error signal, along with the LORAN Observation Matrix (H_{LOR}) and the corresponding Kalman Gain Matrix (K) are combined in the “Update States and Covariances” function to produce the post measurement filter states and covariance matrix. These elements are then used as the initial states and covariances for the next measurement observation sequences.

LORAN range measurement uncertainty is specific to each incoming measurement and approximated using the input Signal-to-Noise Ratio (SNR) provided to the integrator with the LORAN input string described above. Possible Optimizations for the US Loran System, Johnson et al., Position, Location and Navigation Symposium, 2006 IEEE/ION, April 25-27, incorporated herein by reference, describes a method of converting LORAN signal strength (SS) to the standard deviation in the resulting time-of-arrival (TOA) measurement. The total TOA noise is resolved into two components:

w_{TOA}(i)=w_{Channel}(i)+wⱼᵢₜₜₑᵣ(i) (16)

In equation (16), the first term on the right is the “channel noise” for each transmitter, derived from the SNR for that specific measurement and the second term on the right is the noise from jitter, simply a function of the station rating (dual or single). The “i” index represents the i^{th} specific transmitter. In the Johnson reference, the contribution to the total TOA standard deviation (τ_{TOA}) from the channel noise is derived from signal strength (SS)

$${σ}_{channel} ( i ) = {10}^{\frac{( 123 - SS )}{20}} \qquad ( 17 )$$

The total TOA standard deviation for a specific (i^{th}) transmitter is then the RSS of the two components:

τ_{TOA}(i)=\sqrt{τ_{channel}²(i)+ⱼᵢₜₜₑᵣ²(i)} (18)

In the Johnson reference, there are two jitter values provided—one for a single-rated station and one for a dual rated station:

τⱼᵢₜₜₑᵣ (single-rated)=60 n sec

τⱼᵢₜₜₑᵣ (dual-rated)=90 n sec (19)

The signal strength in equation (17) is approximated here by:

SS(i)=SNR(i)+NoiseFloor (20)

In equation (20), the noise floor has been provided as 50-55 db.
Finally, the result of equation (18) is the TOA standard deviation in nsec. This is converted to micro-seconds (usec) and then to range in meters:

$${σ}_{Range} ( i ) = \frac{{σ}_{TOA} ( i )}{1000} * {V}_{light} \qquad ( 21 )$$

where V_{light} is the speed of light in air in units of meters/usec.

The LG integrator of the present invention contemplates the following considerations.

1. Earth Modeling for Processing of LORAN Measurements
a. A simple spherical Earth model is employed in conjunction with the Haversine formulation for range calculations and processing of LORAN Measurements.
b. May be converted to range computations utilizing higher-fidelity Earth modeling techniques such as that described in related literature.

2. Addition of individual eLORAN range correction states
a. Optionally to include path specific ASF (conductivity) correction states for each active LORAN transmitter.
b. Optionally formulate with “on-line” parameter identification of conductivity model coefficients
c. Feedback used to correct ensuing range measurements.
d. Evaluate performance in terms of increased robustness during GPS outages.
e. Capable of path corrections in both static and dynamic receiver environments.

3. Utilizing GPS pseudo-ranges for increased robustness and accuracy
a. Baseline system utilizes GPS position/velocity solution
b. Integration of pseudo-ranges will provide access to GPS measurements even during periods where no position/velocity solution is available.
c. The corresponding error signal may be formed by differencing the specific pseudo-range measurement with the estimated version of this range, computed using the estimated receiver position and the known satellite ephemeris.
d. May also provide improved observability into GPS clock bias error.

The LG integrator system of the present invention may be described in the general context of computer-executable instructions, such as program modules, being executed by a computer. Generally, program modules include routines, programs, objects, components, data structures, etc. that perform particular tasks or implement particular abstract data types. The system of the present invention may also be practiced in distributed computing environments where tasks are performed by remote processing devices that are linked through a communications network or other data transmission medium. In a distributed computing environment, program function modules and other data may be located in both local and remote computer storage media including memory storage devices.

The computer processing device or devices and interactive drives, memory storage devices, databases and peripherals may be interconnected through one or more computer system buses. The system buses may be any of several types of bus structures including a memory bus or memory controller, a peripheral bus, and a local bus using any of a variety of bus architectures. By way of example, and not limitation, such architectures include Industry Standard Architecture (USA) bus, Micro Channel Architecture (MCA) bus, Enhanced ISA (EISA) bus, Video Electronics Standards Association (VESA) local bus, and Peripheral Component Interconnect (PCI) bus.

The computing device typically includes a variety of computer readable media. Computer readable media can be any available media that can be accessed by a computing device and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computing device.

The computing system suitable for carrying out the computer-executable instructions may further include computer storage media in the form of volatile and/or non-volatile memory such as Read Only Memory (ROM) and Random Access memory (RAM). RAM typically contains data and/or program modules that are accessible to and/or operated on by the computer processing device. That is, RAM may include application programs, such as the functional modules of the system of the present invention, and information in the form of data. The computer system may also include other removable/non-removable, volatile/non-volatile computer storage and access media. For example, the computer system may include a hard disk drive to read from and/or write to non-removable, non-volatile magnetic media, a magnetic disk drive to read to and/or write from a removable, non-volatile magnetic disk, and an optical disk drive to read to and/or write from a removable, non-volatile optical disk, such as a CD-ROM or other optical media. Other removable/non-removable, volatile/non-volatile computer storage media that can be used in the computer system to perform the functional steps associated with the system and method of the present invention include, but are not limited to, magnetic tape cassettes, flash memory cards, digital versatile disks, digital video tape, solid state RAM, solid state ROM, and the like.

The drives and their associated computer storage media described above provide storage of computer readable instructions, data structures, program modules and other data for the computer processing device. A user may enter commands and information into the computer processing device through input devices such as a keyboard and a pointing device, such as a mouse, trackball or touch pad. These and other input devices are connected to the computer processing device through the system bus, or other bus structures, such as a parallel port, game port or a universal serial bus (USB), but is not limited thereto. A monitor or other type of display device is also connected to the computer processing device through the system bus or other bus arrangement. In addition to the monitor, the computer processing device may be connected to other peripheral output devices, such as printers.

The computer processing device may be configured and arranged to perform the functions and steps described herein embodied in computer instructions stored and accessed in any one or more of the manners described. The functions and steps, such as the functions and steps of the present invention described herein, individually or in combination, may be implemented as a computer program product tangibly as computer-readable signals on a computer-readable medium, such as any one or more of the computer-readable media described. Such computer program product may include computer-readable signals tangibly embodied on the computer-readable medium, where such signals define instructions, for example, as part of one or more programs that, as a result of being executed by the computer processing device, instruct the computer processing device to perform one or more processes or acts described herein, and/or various examples, variations and combinations thereof. Such instructions may be written in any of a plurality of programming languages, for example, XML, Java, Visual Basic, C, or C++, Fortran, Pascal, Eiffel, Basic, COBOL, and the like, or any of a variety of combinations thereof. The computer-readable medium on which such instructions are stored may reside on one or more of the components described above and may be distributed across one or more such components.

Alternatively, the LG integrator system of the present invention may be constructed from a combination of software and hardware or all hardware. Such hardware suitable for implementing the functions described herein include electronic components such as transistors, capacitors, resistors, operational amplifiers, comparators, and other components. These components can be used to implement functions such as addition, multiplication, integration, analog value comparison and most other mathematic and logical functions of the type required to carry out the capabilities of the system of the present invention.

One or more example embodiments to help illustrate the invention have been described herein and in the priority document incorporated herein by reference. Nevertheless, it will be understood that various modifications may be made without departing from the spirit and scope of the invention. Accordingly, other embodiments are within the scope of the claims appended hereto.

What is claimed is:

1. A system to assist in optimizing position, velocity and heading determinations by integrating range measurements from a LORAN signal source and measurements from a GPS signal source, the system comprising:
a. a first input for receiving one or more signals from the LORAN signal source;
b. a second input for receiving one or more signals from the GPS signal source; and
c. a computing device including an integrator coupled to the first input and to the second input, wherein the integrator is configured to generate outputs associated with the first input and the second input to provide a best estimate of one or more position, velocity and bearing indicators based on information received from the LORAN signal source and the GPS signal source over time.

2. The system of claim 1 further comprising a LORAN signal preprocessor coupled between the first input and the integrator, wherein the LORAN signal preprocessor is arranged to generate an information input string containing information in a selectable format suitable for blending.

3. The system of claim 2 wherein the LORAN signal preprocessor is arranged to produce one or more of a LORAN clock generated time-stamp, a number indicating the number of valid LORAN transmitter stations associated with the first input, a LORAN quality indicator, a LORAN content indicator, a LORAN latitude fix, a LORAN longitude fix, a pseudo-range data set, one or more LORAN bearing measurements and a heading mode indicator.

4. The system of claim 2 further comprising a GPS signal preprocessor coupled between the second input and the integrator, wherein the GPS signal preprocessor is arranged to generate an information input string containing information in a selectable format suitable for blending to establish output error determinations.

5. The system of claim 4 wherein the GPS signal preprocessor is arranged to produce one or more of a GPS clock generated time-stamp, a GPS quality indicator, a GPS latitude fix, a GPS longitude fix, a GPS altitude fix, a GPS velocity east, a GPS velocity north, a GPS velocity up and a GPS position error data set.

6. The system of claim 1 wherein the integrator is further configured to process bearing related information identified as a particular bearing sub-mode associated with one or more of the first input and the second input.

7. The system of claim 6 wherein heading sub-modes of the integrator include BAV_NoCal, BO_NoCal, BAV_PostCal, BO_PostCal, PosVel, BAV_Cal and BO_Cal.

8. The system of claim 1 wherein the integrator includes means to accommodate a plurality of input measurement content permutations, wherein each input measurement content permutation is identified as a particular navigation mode associated with each of the first input and the second input.

9. The system of claim 8 wherein navigation modes of the integrator include LOR_ALL_GPS, LOR_RNG_GPS, GPS, LOR_TD, LOR_POS, LOR_RNG and NONE.

10. The system of claim 1 wherein the integrator outputs to further signal processing means, a display, or a combination of the two one or more of receiver latitude solution, receiver longitude solution, receiver altitude solution, receiver east velocity solution, receiver north velocity solution, receiver up velocity solution, LORAN correction term solutions, receiver heading solution, receiver horizontal velocity solution, initialization phase complete indicator, navigation mode indicator, heading mode indicator and integrator information.

11. The system of claim 10 further comprising one or more additional inputs for receiving either or both of input signals from external sensors and inertial sensors.

12. The system of claim 1 wherein the integrator includes a Kalman filter arrangement including one or more filters comprising sub-modes of the integrator configured as error-state filters to estimate errors in trajectory variables.

13. The system of claim 12 wherein the error-states of the Kalman filter are designed to accommodate the correlation of heading and velocity without first receiving calibration information and the Kalman filter is defined as a function of the variables:
\hat{x}_{BAV}_{_{—}}_{NoCal}=[δ_{φ}δ_{λ}δₕδ_{V}_{_{H}}δ_{V}_{_{U}}δ_{ψ}δ_{B}_{_{L}}δ_{A}_{₀}] (1)
wherein the first three terms represent the errors in the estimates of receiver latitude, longitude and altitude, the second three terms represent the errors in the estimates of receiver horizontal and vertical velocity and heading, the seventh term is an optional bias correction estimate for the LORAN range measurements and the final term is an optional bias correction estimate for bearing error correction.

14. The system of claim 12 wherein the integrator is configured to:
a. difference signals of the second input with the Kalman filter's current estimate of corresponding states to produce position, velocity and heading error signal observations;
b. update the states and covariances according to the observations utilizing the corresponding Kalman Gain Matrix and GPS Observation Matrix; and
c. propagate the updated states and covariances to the time of the next observation.

15. The system of claim 14 wherein the integrator is further configured to:
a. difference signals of the first input for all utilized LORAN transmitter stations with an initial estimation thereof, wherein the initial estimation is computed using estimated receiver position and the known locations of the utilized LORAN transmitter stations to produce a LORAN observable range error signal;
b. combine the observable range error signal with the LORAN Observation Matrix and the corresponding Kalman Gain Matrix to produce updated filter states and covariance matrix to be used as the initial states and covariances for the next measurement observation sequences; and
c. propagate receiver states to the time of the next observation with a first-order propagation method.

16. The system of claim 1 wherein the integrator is further configured to estimate corrections of specific LORAN range and/or path errors by including filter components to learn LORAN errors while GPS input information is available and then making corrections based on the learned LORAN errors when the GPS input information is unavailable.
